(19) United States
(12) Patent Application Publication
(10) Pub. No.: US 2008/0057265 A1
(43) Pub. Date: Mar. 6, 2008

(54) Electromagnetic Interference Shielding Structure Including Carbon Nanotubes and Nanofibers

(75) Inventors: Zhiyong Liang, Tallahassee, FL (US); Ben Wang, Tallahassee, FL (US); Chun Zhang, Tallahassee, FL (US)

Correspondence Address: SUTHERLAND ASBILL & BRENNAN LLP, 999 PEACHTREE STREET, N.E., ATLANTA, GA, 30309, US

(73) Assignee: FLORIDA STATE UNIVERSITY RESEARCH FOUNDATION, Tallahassee, FL (US)

(21) Appl. No.: 11/751,655

(22) Filed: May 22, 2007

Related U.S. Application Data
(60) Provisional application No. 60/747,879, filed on May 22, 2006.

(51) Int. Cl. B05D 5/12; B29C 65/00; B29C 65/02; B29C 65/48; B32B 33/00; B32B 5/12

(52) U.S. Cl. 428/114; 156/320; 156/330; 156/60; 427/96.3; 428/304.4; 428/336; 428/411.1; 428/543; 428/688

(57) ABSTRACT

Electromagnetic interference (EMI) shielding structure and methods of making such structures are provided. In one case, a method is provided for making a lightweight composite structure for electromagnetic interference shielding, including the steps of providing a nanoscale fiber film which comprises a plurality of nanoscale fibers; and combining the nanoscale fiber film with one or more structural materials to form a composite material which is effective as an electromagnetic interference shielding structure. In another case, a method is provided for shielding a device which includes an electrical circuit from electromagnetic interference comprising the steps of providing a nanoscale fiber film which comprises a plurality of nanoscale fibers; and incorporating the nanoscale fiber film into an exterior portion of the device to shield an interior portion of the device from electromagnetic interference.

### CROSS-REFERENCE TO RELATED APPLICATIONS

This application claims benefit of U.S. Provisional Application No. 60/747,879, filed May 22, 2006. This application is incorporated herein by reference.

### STATEMENT REGARDING FEDERALLY SPONSORED RESEARCH OR DEVELOPMENT

This invention was made with U.S. government support under Award No. FA9550-05-1-0271 awarded by the Air Force Office of Scientific Research. The U.S. government has certain rights in the invention.

### BACKGROUND OF THE INVENTION

This invention is generally in the field of materials useful for shielding electromagnetic radiation, and more particularly in the field of electromagnetic interference shielding structures that comprise films which include nanotubes, other nanofibers, and the like.

Electromagnetic interference shielding structures are used to prevent electromagnetic radiation from interfering with the operation of electronic devices including but not limited to computer systems, communications equipment (e.g., telephones), televisions, radios, and medical instruments. Conventional methods of shielding electronic devices include enclosing the devices in metal cabinets, housings or cages, and coating the devices with metal coatings. Unfortunately, these methods add significant weight to the devices, increase fabrication costs, and may present corrosion problems in long term applications. It therefore would be useful to provide methods and structures for substantially shielding electronic devices, wherein the structures are relatively light, can be provided and incorporated into devices at relatively low cost while adding little weight to the device, and are corrosion resistant.

### SUMMARY OF THE INVENTION

In one aspect, methods are provided for shielding a device which includes an electrical circuit from electromagnetic interference. In one embodiment, the method may include the steps of: (a) providing a nanoscale fiber film which comprises a plurality of nanoscale fibers; and (b) incorporating the nanoscale fiber film into an exterior portion of the device to shield an interior portion of the device from electromagnetic interference.

The step of providing the nanoscale fiber film may include providing a plurality of nanoscale fibers; dispersing the plurality of nanoscale fibers into a liquid to form a suspension; and removing the liquid to form a nanoscale fiber film. In one embodiment, the step of removing the liquid includes filtration, vaporization, or a combination thereof. The method may further include coating the nanoscale fibers with a metal material before the step of dispersing the nanoscale fibers. The method also may include aligning the nanoscale fibers after the step of dispersing the nanoscale fibers and before the step of removing the liquid. In one embodiment, the step of incorporating the nanoscale fiber film may include adhering one or more layers of the nanoscale fiber film with an adhesive material to at least one surface of the device.

In another aspect, an electromagnetic interference shielded device is provided. The shielded device may have an average electromagnetic wave attenuation of at least about 21 dB between the frequencies of about 200 MHz and about 500 M z, and at least about 30 dB between the frequencies of about 4 GHz and about 18 GHz. In one embodiment, the shielded devices includes a device which includes an exterior portion and an interior portion having an electrical circuit disposed therein; and at least one nanoscale fiber film which comprises a plurality of nanoscale fibers, wherein the at least one nanoscale fiber film material is part of the exterior portion of the device.

In a preferred embodiment, one or more layers of the nanoscale fiber film are attached to a surface of the exterior portion or are part of a composite material of construction forming at least part of the exterior portion of the device. The nanoscale fiber film may have a thickness between 5 and 50 microns. In a particular embodiment, a structural material is impregnated into spaces among the plurality of nanoscale fibers. The structural material may include a polymeric material, such as an epoxy.

In yet another aspect, methods are provided for making a composite structure for electromagnetic interference shielding. In one embodiment, the method includes the steps of: (a) providing a nanoscale fiber film which comprises a plurality of nanoscale fibers; and (b) combining the nanoscale fiber film with one or more structural materials to form a composite material which is effective as an electromagnetic interference shielding structure. In one embodiment, the composite material includes a laminate structure.

In a particular embodiment, the step of combining the film material with the structural materials includes impregnating the nanoscale fiber film with a flowable (e.g., material to form an impregnated nanoscale fiber film and then solidifying the flowable material. The flowable material may include an epoxy resin and the solidifying step may include curing the epoxy resin. The flowable material may include a thermoplastic material heated above its melting temperature and the solidifying step may include cooling the thermoplastic material to below its melting temperature. As used herein, the term “flowable material” generally refers to a pure liquid, a liquid solution, emulsion, or a solid-in-liquid suspension.

In yet another aspect, a composite structure for shielding electromagnetic interference is provided. In one embodiment, the composite structure includes at least one nanoscale fiber film which comprises a plurality of nanoscale fibers; and one or more structural materials combined with the at least one nanoscale fiber film to provide a composite material structure for shielding electromagnetic interference. In one embodiment, the composite structure includes a laminate structure. The composite material structure may include two or more layers of the nanoscale fiber film. In one embodiment, the one or more structural materials includes an epoxy or another polymeric material. The one or more structural materials may be electrically non-conductive, may include a solid foam or porous substrate, and may comprise a glass fiber material. In a particular embodiment, the one or more structural materials are impregnated into spaces among the plurality of nanoscale fibers. The composite structure may have an average electromagnetic wave attenuation of at least about 21 dB between the frequencies of about 200 MHz and about 500 MHz, and at least about 30 dB between the frequencies of about 4 GHz and about 18 GHz.

### BRIEF DESCRIPTION OF THE DRAWINGS

FIGS. 1A and 1B are illustrations showing possible embodiments of methods for making EMI shielding composite structures.

FIG. 2 is a cross-sectional view of one embodiment of an electronics device which includes EMI shielding material.

FIG. 3 is a graph which shows EMI attenuation over a frequency range between 200 MHz and 500 MHz.

FIG. 4 is a graph which shows EMI attenuation over a frequency range between 4 GHz and 18 GHz.

### DETAILED DESCRIPTION OF THE INVENTION

Methods have been developed for making an electromagnetic interference (EMI) shielded device and an EMI shielded structure using a film material of nanoscale fibers. This EMI shield advantageously may be thin, flexible, lightweight, corrosive resistant, and provide exceptional electromagnetic wave attenuation. Furthermore, the properties of the nanoscale fiber film enable ease of handling, which beneficially may provide for low cost mass production.

As used herein, the terms “comprise,” “comprising,” “include,” and “including” are intended to be open, non-limiting terms, unless the contrary is expressly indicated.

The Methods

In one aspect, a method is provided for shielding a device, which includes an electrical circuit, from electromagnetic interference. In one embodiment, this method may include the steps of: (a) providing a film material which comprises a plurality of nanoscale fibers; and (b) incorporating the film material into an exterior portion of the device to shield an interior portion of the device from electromagnetic interference. The device desirably may be, or include a component, in need of EMI shielding, such as an electronics device.

In another aspect, a method is provided for making a composite structure for electromagnetic interference shielding. In one embodiment, the method may include the steps of: (a) providing a film material which comprises a plurality of nanoscale fibers; and (b) combining the film material with one or more structural materials to form a composite material which is effective as an electromagnetic interference shielding structure. The composite structure can be used in the construction of myriad devices and components, wherein EMI shielding may be desired or needed. For example, an electronics device may be encased in the composite material.

Providing the Nanoscale Fiber Film

The EMI shielding structure and EMI shielding device may include essentially any nanoscale fiber film. As used herein, the term “nanoscale fiber film” refers to a film material, e.g., a thin sheet, of nanoscale fibers dispersed in a network, and the term “nanoscale fibers” refers to a thin, greatly elongated solid material, typically having a cross-section or diameter of less than 500 nm. The nanoscale fibers may comprise various carbon nanoscale fibers.

In a particular embodiment, the nanoscale fibers comprise carbon nanoscale fibers such as single walled carbon nanotubes (SWNTs), multiple-walled carbon nanotubes (MWNTs), carbon nanofibers (CNFs), or mixtures thereof. SWNTs typically have small diameters (˜1-5 nm) and large aspect ratios, while MWNTs typically have large diameters (˜5-200 nm) and smaller aspect ratios. CNFs are filamentous fibers resembling whiskers of multiple graphite sheets. As used herein, the term “carbon nanotube” refers to carbon fullerene, a synthetic graphite, which typically has a molecular weight of between about 840 and about 10 million or more. Carbon nanotubes are commercially available, for example, from Carbon Nanotechnologies, Inc. (Houston, Tex.), or can be made using techniques known in the art. In a preferred embodiment, the nanoscale fibers comprise or consist of carbon nanotubes, including both SWNTs and MWNTs (multiple-walled carbon nanotubes).

The nanoscale fibers optionally may be chemical modified or coated with other materials such as metals. For example, copper, nickel, and silver may be coated onto carbon nanotubes, for example, by using a sputtering coating process or by using an electrochemical deposition process, as those processes are known in the art. The nanotubes optionally may be opened or chopped, for example, as described in U.S. Patent Application Publication No. 2006/0017191 A1, which is incorporated herein by reference.

The nanoscale fiber film may be made by essentially any suitable process known in the art. In a particular embodiment, the nanoscale fiber film is made by process that includes (1) providing a plurality of nanoscale fibers; (2) dispersing the plurality of nanoscale fibers into a liquid to form a solution or suspension; and (3) removing the liquid to form a nanoscale fiber film.

The liquid may include a non-solvent, a solvent, or a combination thereof, The liquid optionally may include a surfactant (such as Triton X-100, Fisher Scientific Company, NJ) to enhance dispersion and stabilize the suspension. As used herein, the term “non-solvent” refers to a liquid that is essentially non-reactive with the nanofibers and in which the nanofibers are virtually insoluble. Non-limiting examples of suitable non-solvent liquids include volatile organic liquids, such as acetone, ethanol, methanol, and n-hexane. In a preferred embodiment, the liquid has a low boiling point so that it can be quickly and easily removed from the suspension. The step of removing the liquid may include filtration, vaporization, or combinations thereof. In a preferred embodiment, the nanoscale fibers are dispersed in water, or an aqueous solution, to make a suspension and then the suspension is filtered to form a nanoscale fiber film.

The nanoscale fibers can be randomly dispersed in the film or can be aligned in the film. An aligned nanoscale fiber film may be prepared, for example, using in situ filtration of a suspension in a high strength magnetic field, as described in U.S. Patent Application Publication No. 2005/0239948 to Haik et al., which is incorporated herein by reference.

The nanoscale fiber film optionally may be irradiated. The irradiation process may be conducted with a controlled application of an energetic beam, such as an electron beam, an ion particle beam, or an ultraviolet (UV) light beam, using techniques and equipment known in the art. The energetic beam is applied in a controlled manner so that one or more mechanical and other physical properties of the nanoscale fiber film is changed. Non-limiting examples of these mechanical properties include strength, tensile strength, toughness, and strain resistance.

In one embodiment, the nanoscale film is from 5 to 50 microns thick with a typical area density of 0.0705 oZ/ft² (or 21.5 gIm²) or greater. The nanoscale fiber film optionally may be impregnated with a resin or other flowable material (e.g., a thermoplastic polymer).

Combining the Film with a Structural Material

The step of combining the nanoscale fiber film with one or more structural materials to form a composite material can be done using a variety of techniques known in the art that suitably preserve the integrity of the nanoscale fiber film. A wide variety of structural materials are envisioned for use in the construction of the composite material. In one embodiment, the structural materials may include essentially any low conductive substrate or structure. For example, the structural material may include foams, honeycombs, glass fiber laminates, Kevlar fiber composites, polymeric materials, or combinations thereof. Non-limiting examples of suitable structural materials include polyurethanes, silicones, fluorosilicones, polycarbonates, ethylene vinyl acetates, acrylonitrile-butadiene-styrenes, polysulfones, acrylics, polyvinyl chlorides, polyphenylene ethers, polystyrenes, polyamides, nylons, polyolefins, poly(ether ether ketones), polyimides, polyetherimides, polybutylene terephthalates, polyethylene terephthalates, fluoropolymers, polyesters, acetals, liquid crystal polymers, polymethylacrylates, polyphenylene oxides, polystyrenes, epoxies, phenolics, chlorosulfonates, polybutadienes, buna-N, butyls, neoprenes, nitriles, polyisoprenes, natural rubbers, and copolymer rubbers such as styrene-isoprene-styrenes, styrene-butadiene-styrenes, ethylene-propylenes, ethylene-propylene-diene monomers (EPDM), nitrile-butadienes, and styrene-butadienes (SBR), and copolymers and blends thereof. Any of the forgoing materials may be used unfoarned or, if required by the application, blown or otherwise chemically or physically processed into an open or closed cell foam.

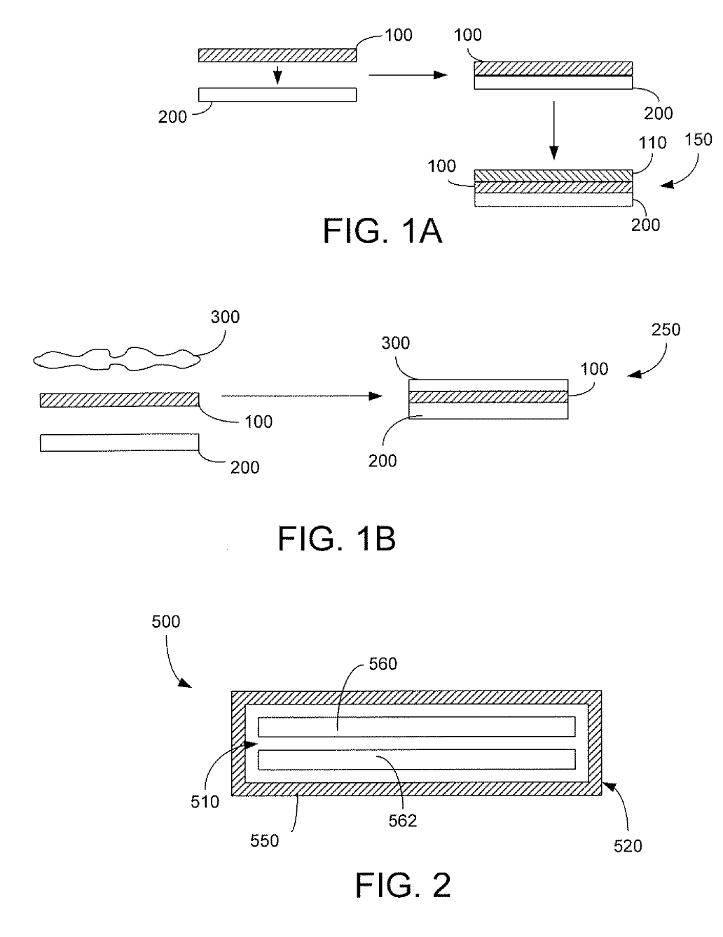

In one embodiment, one or more nanoscale fiber films may be attached to at least one side of a structural material. FIG. 1A shows a process for making an EMI shielding structure wherein a first nanoscale fiber film material 100 is combined with a structural material 200, and optionally combined with a second nanoscale fiber film material 110, to form a composite material 150. The film may be permanently attached or secured in a removably attached position adjacent the composite material using any of a variety of adhering or fastening means known in the art. In one embodiment, the EMI shielding composite may comprise multiple layers of nanoscale film materials and composite materials.

In another embodiment, the step of combining the nanoscale fiber film with one or more structural materials comprises impregnating the nanoscale fiber film with a flowable material. The “flowable material” is, or is a precursor of the one or more structural materials, which are provided in a fluid form during manufacture of the composite. The solidifying step may occur by a chemical or physical change in the structural material. In one embodiment, the flowable material comprises a epoxy resin and the solidifying step comprises curing the epoxy resin. In one case, the flowable material undergoes a curing process following contact with the nanoscale fiber film. Non-limiting examples of suitable co-curing processes include hand lay-up, VaRTM (vacuum added resin transfer molding)/RTM (resin transfer molding), and pregreg/vacuum bagging. In another embodiment, the flowable material comprises a thermoplastic material heated above its melting temperature and the solidifying step comprises cooling the thermoplastic material to below its melting temperature. FIG. 1B shows a process for making an EMI shielding structure wherein a first nanoscale fiber film material 100 is combined with a structural material 200 and flowable material 300 optionally combined with a second nanoscale fiber film material 110, to form a composite material 150.

Using no more than routine experimentation, one skilled in the art can selected structural materials for use with the nanoscale fiber film, based on properties such as operating temperature, hardness, chemical compatibility, resiliency, compliancy, compression-deflection, compression set, flexibility, ability to recover after deformation, modulus, tensile strength, elongation, force defection, flammability, or any other chemical or physical property.

Incorporating the Film into a Device

The step of incorporating the nanoscale fiber film into an exterior portion of the device may include adhering one or more layers of the nanoscale fiber film with an adhesive material to at least one surface of the device. The nanoscale fiber film may be on the outer surface of device or may be an intermediate layer in the exterior portion. The nanoscale fiber film may be part of a laminate structure or other composite structure in or on the exterior portion of the device. The terms “exterior portion” and “interior portion” are used herein to refer to relative orientations of the part(s) of the device that are to be shielded (i.e., interior portion) from externally generated EMI and the part(s) of the device that at least partially surround these interior portions in order to provide the desired shielding (i.e., the exterior portion). A single device may include multiple EMI shielding structures and may have shielding structures arranged to shield one or more components from EMI generated by externally and/or internally another component within the device.

The step of incorporation may involve adhering, fastening, or otherwise attaching the nanoscale fiber film to a surface of a part of the device using essentially any suitable means known in the art. The step of incorporation may include building the nanoscale fiber film into a composite material of construction used to fabricate one or more parts of the device. For example, the composite material may serve as a substrate on which microelectronics are mounted or may be made into an encasement for a subcomponent of the device or for the whole device. In one embodiment, the step of attaching the nanoscale fiber film comprises gluing the nanoscale fiber film to at least one surface of the device using essentially any known glue or adhesive. For example, the adhesive may be an epoxy or a pressure-sensitive adhesive known in the art.

In a preferred embodiment, a plurality of nanoscale fiber film layers may be stacked together. The multiple layers of nanoscale fiber film may have other structural or barrier material layers interposed therebetween. In one case, the step of incorporating the nanoscale fiber film may include adhering two or more layers of the nanoscale fiber film to at least one surface of the device. A single film may be wrapped around the device in overlapping layers.

The device may be virtually any device that includes an electronic circuit, non-limiting examples of which include computers, mobile and landline telephones, televisions, radios, personal digital assistants, digital music players, medical instruments, automotive vehicles, aircraft, and satellites.

The Composite Structure and the Shielded Device

In still another aspect, an electromagnetic interference shielded device is provided. It includes a device which includes an exterior portion and an interior portion having an electrical circuit disposed therein; and at least one nanoscale fiber film which comprises a plurality of nanoscale fibers, wherein the at least one nanoscale fiber film material is part of the exterior portion of the device. In yet another aspect, a composite structure is provided for shielding electromagnetic interference. This composite structure includes at least one nanoscale fiber film which comprises a plurality of nanoscale fibers; and one or more structural materials combined with the at least one nanoscale fiber film to form a composite material structure for shielding electromagnetic interference.

The EMI shielding structures may be used in essentially any application in which EMI shielding is desired, and are particularly useful in applications where lightweight and/or thin construction is critical.

FIG. 2 shows a generic EMI shielded device 500, which includes exterior portion 520 surrounding interior portion 510. The interior portion includes electrical circuit-containing components 560 and 562. The exterior portion includes a composite structural/shielding material 550 which includes one or more nanoscale fiber films. In one embodiment, the composite structural/shielding material includes at least one layer of nanoscale fiber film that is attached to an exterior surface of rigid, base material of construction. In another embodiment, the composite structural/shielding material includes at least one layer of nanoscale fiber film which has a structural material impregnated within spaces among the plurality of nanoscale fibers. The composite structural material shields electrical circuit-containing components from EMI generated external to the device.

The composite structural/shielding material may have an average electromagnetic wave attenuation of at least about 21 dB between the frequencies of about 200 MHz and about 500 MHz, of at least about 30 dB between the frequencies of about 4 GHz and about 180 Hz.

The present invention is further illustrated by the following non-limiting examples.

### EXAMPLE 1

### EMI Attenuation of a Foam Sandwich Composite Structure with Two Layers of Randomly Dispersed SWNT Films

An EMI shielding structure which included randomly dispersed nanotube films was tested for radio frequency (RF) attenuation.

Purified SWNTs were obtained from Carbon Nanotechnologies Inc. (Houston, Tex.). Nanotube films were prepared from the SWNTs as follows: The SWNTs were dispersed with sonification into distilled water containing Triton X-100 surfactant in order to form a stable suspension. The SWNT concentration in the suspension was 40 mg/L. Next, about 12 to 15 liters of suspension was filtered using a custom-made filter with a 0.45 μm nylon filter membrane from Millipore, Inc. (Billerica, Mass.). The filtration process yielded a SWNT film (i.e., a sheet or membrane). The film was then washed using isopropanol. The length and width dimensions of the SWNT film were about 9 inches by 9 inches.

Composite structures were prepared as follows: The film was cut into 6 inch by 4 inch pieces. Next, a sandwich structure was fabricated with the SWNT films, EPON 862 epoxy resin (Shell Chemicals), and a 2 mm thick layer of ROHACELL™ polymethacrylimide (PMI) foam (Degussa GmbH, Dusseldorf, Germany). Two layers of the SWNT films were impregnated with EPON 862 resin. The resin impregnated films were then co-cured onto the surface of the foam using a vacuum bag to form the SWNT composite structure. The total weight of SWNT's was under 700 mg over the 6 in. by 4 in. area.

EMI shielding tests were conducted by Lockheed Martin Missiles and Fire Control (Orlando, Fla.) in accordance with MIL-STD-285 guidelines, using an aluminum box with one open side. The dimensions of the open side panel were approximately the same size as the composite structure, and a metallic grounding structure was added to prevent radiation from entering the aluminum box through gaps or holes between the composite structure and the box. The external transmitted RF field and the received energy penetrating the composite structure was detected within the shielded box to measure of EMI attenuation of the composite structure.

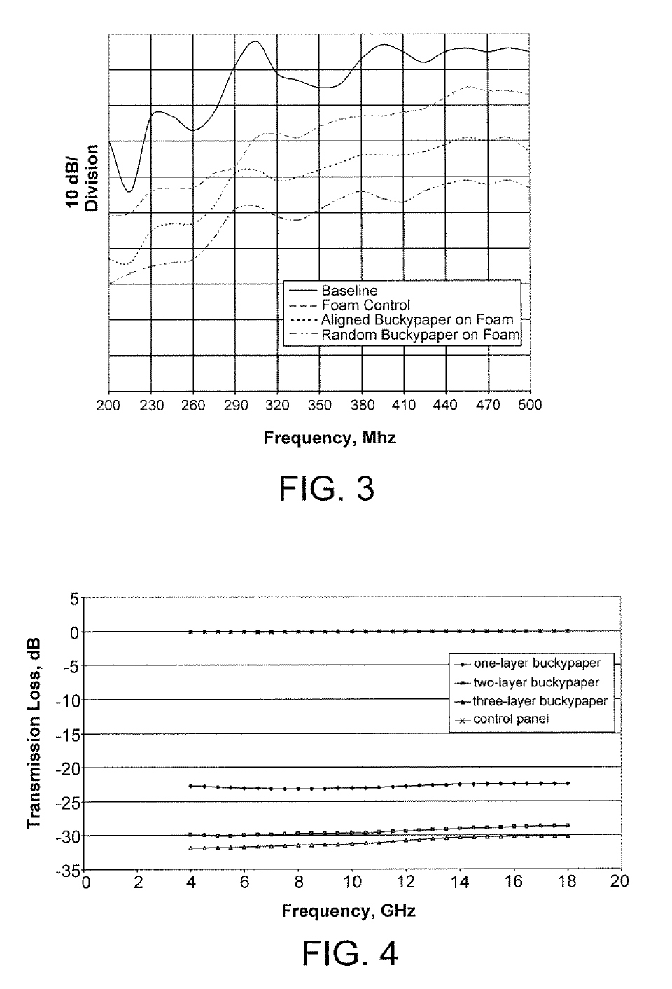

FIG. 3 shows the results of the EMI shielding tests over a low frequency range between 200 MHz and 500 MHz for the randomly dispersed composite structure in comparison to a baseline (empty or without any shielding materials) and a 2 mm thick ROHACELL PMI foam panel (control panel). The tests showed that as compared to the pure foam control sample, the composite structure achieved attenuation as great as 26 dB at about 455 MHz to 500 MHz, and an average attenuation of 21 dB across the entire frequency range.

### EXAMPLE 2

### EMI Attenuation of a Foam Sandwich Composite Structure with Two Layers of Aligned SWNT Films

An EMI shielding composite structure which included magnetically aligned nanotube films was tested for RF attenuation. The composite structure was prepared and tested as described in Example 1, except that the SWNT films were produced under the influence of a magnetic field to align the nanotubes. The SWNT films were cut and assembled with foam such that the two layers of SWNT films had the same alignment direction along the 4-inch direction of the samples.

FIG. 3 shows the results of the EMI shielding tests over a low frequency range between 200 MHz and 500 MHz for the aligned composite structure in comparison to a baseline (empty or without any shielding materials) and a 2 mm thick ROHACELL PMI foam panel (control panel). The tests showed that as compared to the pure foam control sample, the composite structure achieved attenuation as great as 16 dlB at about 500 MHz, and an average attenuation of 11 dB across the entire frequency range.

### EXAMPLE 3

### EMI Shielding Composite

### Foam with One, Two, and Three Layers of Randomly Dispersed SWNT Film Surface Skins

EMI shielding composite structures which included one, two, and three layers of randomly dispersed nanotube films were tested for RF attenuation. The composite structure was prepared and tested as described in Example 1, except that the EMI shielding test was performed over a 4 GHz and 180 Hz range.

FIG. 4 shows the results of the EMI shielding tests in comparison to a foam panel (control panel). The tests showed that as compared to the pure foam control sample, the composite structure achieved attenuation as great as 30 dB.

Publications cited herein are incorporated by reference. Modifications and variations of the methods and devices described herein will be obvious to those skilled in the art from the foregoing detailed description. Such modifications and variations are intended to come within the scope of the appended claims.

We claim:

1. A method for shielding a device which includes an electrical circuit from electromagnetic interference comprising the steps of:
(a) providing a nanoscale fiber film which comprises a plurality of nanoscale fibers; and
(b) incorporating the nanoscale fiber film into an exterior portion of the device to shield an interior portion of the device from electromagnetic interference.

2. The method of claim 1, wherein step (a) includes providing a plurality of nanoscale fibers; dispersing the plurality of nanoscale fibers into a liquid to form a suspension; and
removing the liquid to form a nanoscale fiber film.

3. The method of claim 2, wherein the step of removing the liquid comprises filtration, vaporization, or a combination thereof.

4. The method of claim 2, further comprising the step of coating the nanoscale fibers with a metal material before the step of dispersing the nanoscale fibers.

5. The method of claim 2, further comprising the step of aligning the nanoscale fibers after the step of dispersing the nanoscale fibers and before the step of removing the liquid.

6. The method of claim 1, wherein step (b) comprises adhering one or more layers of the nanoscale fiber film with an adhesive material to at least one surface of the device.

7. An electromagnetic interference shielded device comprising:
a device which includes an exterior portion and an interior portion having an electrical circuit disposed therein; and
at least one nanoscale fiber film which comprises a plurality of nanoscale fibers,
wherein the at least one nanoscale fiber film material is part of the exterior portion of the device.

8. The device of claim 7, wherein one or more layers of the nanoscale fiber film are attached to a surface of the exterior portion or are part of a composite material of construction forming at least part of the exterior portion of the device.

9. The device of claim 7, wherein the plurality of nanoscale fibers are coated with a metal material.

10. The device of claim 7, wherein the plurality of nanoscale fibers are aligned.

11. The device of claim 7, wherein the plurality of nanoscale fibers comprise carbon nanotubes.

12. The device of claim 7, wherein the nanoscale fiber film has a thickness between 5 and 50 microns.

13. The device of claim 7, wherein a structural material is impregnated into spaces among the plurality of nanoscale fibers.

14. The device of claim 13, wherein the second structural material comprises a polymeric material.

15. The device of claim 14, wherein the polymeric material comprises an epoxy.

16. The device of claim 7, which has an average electromagnetic wave attenuation of at least about 21 dB between the frequencies of about 200 MHz and about 500 MHz.

17. The device of claim 7, which has an average electromagnetic wave attenuation of at least about 30 dB between the frequencies of about 4 GHz and about 18 GHz.

18. A method for making a composite structure for electromagnetic interference shielding, comprising the steps of:
(a) providing a nanoscale fiber film which comprises a plurality of nanoscale fibers; and
(b) combining the nanoscale fiber film with one or more structural materials to form a composite material which is effective as an electromagnetic interference shielding structure.

19. The method of claim 18, wherein the composite material comprises a laminate structure.

20. The method of claim 18, wherein the one or more structural materials comprise a polymeric material.

21. The method of claim 20, wherein the polymeric material comprises an epoxy.

22. The method of claim 18, wherein step (b) comprises impregnating the nanoscale fiber film with a flowable material to form an impregnated nanoscale fiber film and then solidifying the flowable material.

23. The method of claim 22, wherein the flowable material comprises a epoxy resin and the solidifying step comprises curing the epoxy resin.

24. The method of claim 22, wherein the flowable material comprises a thermoplastic material heated above its melting temperature and the solidifying step comprises cooling the thermoplastic material to below its melting temperature.

25. The method of claim 18, wherein step (a) comprises providing a plurality of nanoscale fibers; dispersing the plurality of nanoscale fibers into a liquid to form a suspension; and removing the liquid to form a nanoscale fiber film.

26. The method of claim 25, further comprising the step of coating the nanoscale fibers with a metal material before the step of dispersing the nanoscale fibers.

27. The method of claim 25, further comprising the step of aligning the nanoscale fibers after the step of dispersing the nanoscale fibers and before the step of removing the liquid.

28. A composite structure for shielding electromagnetic interference comprising:
at least one nanoscale fiber film which comprises a plurality of nanoscale fibers; and
one or more structural materials combined with the at least one nanoscale fiber film to provide a composite material structure for shielding electromagnetic interference.

29. The composite structure of claim 28, wherein the composite material comprises a laminate structure.

30. The composite structure of claim 29, wherein the composite material structure includes two or more layers of the nanoscale fiber film.

31. The composite structure of claim 28, wherein the plurality of nanoscale fibers are coated with a metal material.

32. The composite structure of claim 28, wherein the plurality of nanoscale fibers are aligned.

33. The composite structure of claim 28, wherein the plurality of nanoscale fibers comprise carbon nanotubes.

34. The composite structure of claim 28, wherein the nanoscale fiber film has a thickness between 5 and 50 microns.

35. The composite structure of claim 28, wherein the one or more structural materials comprise a polymeric material.

36. The composite structure of claim 35, wherein the polymeric material comprises an epoxy.

37. The composite structure of claim 28, wherein the one or more structural materials are electrically non-conductive.

38. The composite structure of claim 28, wherein the one or more structural materials comprise a solid foam or porous substrate.

39. The composite structure of claim 28, wherein the one or more structural materials comprise a glass fiber material.

40. The composite structure of claim 28, wherein one or more structural materials are impregnated into spaces among the plurality of nanoscale fibers.

41. The composite structure of claim 28, which has an average electromagnetic wave attenuation of at least about 21 dB between the frequencies of about 200 MHz and about 500 MHz.

42. The composite structure of claim 28, which has an average electromagnetic wave attenuation of at least about 30 dB between the frequencies of about 4 GHz and about 18 GHz.
